(19) United States
(12) Patent Application Publication
(10) Pub. No.: US 2026/0194139 A1
(43) Pub. Date: Jul. 9, 2026

(54) TRANSMISSION DEVICE COMPRISING AT LEAST ONE COMPACT DECOUPLING SYSTEM AND AT LEAST ONE CONTROL SYSTEM INTEGRATED IN SAID DECOUPLING SYSTEM

(71) Applicant: Airbus Operations SAS, TOULOUSE (FR)

(72) Inventors: Franck ALVAREZ, TOULOUSE (FR); Vincent MARTY, TOULOUSE (FR)

(21) Appl. No.: 19/439,615

(22) Filed: Jan. 5, 2026

(30) Foreign Application Priority Data
Jan. 6, 2025 (FR) FR2500071

(51) Int. Cl. F16H 63/06; B64D 35/021; B64D 35/08

(52) U.S. Cl. CPC F16H 63/065; B64D 35/021; B64D 35/08

(57) ABSTRACT

A transmission device having: at least first and second shafts, at least one decoupling system which has at least one first coupling sleeve which is permanently coupled in rotation with the second shaft and movable along the second shaft between a first position in which the first coupling sleeve is coupled in rotation with the first shaft and a second position in which the first coupling sleeve is not coupled in rotation with the first shaft, at least one control which comprises at least one chamber adjoining the first coupling sleeve and supplied with fluid, a variation in the volume of the chamber causing a change in position of the first coupling sleeve.

### CROSS-REFERENCES TO RELATED APPLICATIONS

This application claims the benefit of French Patent Application Number FR2500071 filed on Jan. 6, 2025, the entire disclosure of which is incorporated herein by way of reference.

### FIELD OF THE INVENTION

The present application relates to a transmission device comprising at least one compact decoupling system and at least one control integrated into said decoupling system. This transmission device is more particularly adapted to an aircraft propulsion assembly.

### BACKGROUND OF THE INVENTION

According to a first embodiment described in document FR3139554 for example, an aircraft propulsion assembly comprises a propeller, a plurality of electric motors and a transmission device, such as a gearbox for example, configured to couple the electric motors and the propeller. This transmission device comprises, for each electric motor, a coupling system interposed between an input shaft coupled to an electric motor and an output shaft coupled to the propeller.

According to this first embodiment, the coupling system comprises a freewheel which allows mechanical decoupling, only in one direction of rotation, between the electric motor and the propeller.

This coupling system is not fully satisfactory because it does not make it possible to obtain a brake function for the propeller. Thus, under certain flight conditions, under the effect of wind, the propeller can continue to rotate. This rotation generates aerodynamic drag, which results in a loss of aircraft performance.

In addition, when the aircraft is static on the ground, depending on the orientation of the wind, the latter can rotate the propeller. Consequently, it is necessary to put in place specific tools for preventing the propeller from rotating when the aircraft is immobilized on the ground.

According to a second embodiment described in document US20180023635 for example, a transmission device comprises a decoupling system which comprises first and second parts configured to occupy a coupled state, in which the first and second parts cooperate with each other and transmit a torque and/or a rotational movement, and a second state, in which the first and second parts are spaced apart and no longer allow the transmission of a torque and/or a rotational movement. In addition, the transmission device comprises a control such as an actuator, for example, separate from the decoupling system, making it possible to move at least one of the parts of the decoupling system to pass from the first state to the second state, and vice versa.

Even though this solution makes it possible to obtain decoupling in both directions, this second embodiment is not satisfactory because it provides a large number of components, which contributes to complicating and to increasing the mass and bulk of the transmission device.

The present invention is intended to overcome some or all of the drawbacks in the prior art.

### SUMMARY OF THE INVENTION

To that end, the invention relates to a transmission device comprising:
at least first and second shafts,
at least one decoupling system configured to occupy a coupled state in which the first and second shafts are coupled in rotation and a decoupled state in which the first and second shafts are decoupled in rotation,
at least one control configured to control the coupled or decoupled state of the decoupling system,
the decoupling system comprising at least one first coupling sleeve which is permanently coupled in rotation with the second shaft and movable along the second shaft between a first position, corresponding to the coupled state, in which the first coupling sleeve is coupled in rotation with the first shaft, and a second position, corresponding to the decoupled state, in which the first coupling sleeve is not coupled in rotation with the first shaft,
the control comprising at least one chamber adjoining the first coupling sleeve and having a variable volume, at least one fluid supply configured to supply fluid to the chamber, and at least one controller configured to control the fluid supply, a variation in the volume of the chamber causing a change in position of the first coupling sleeve.

According to the invention, the control comprises:
at least one first peripheral transverse wall integral with the first coupling sleeve and delimiting the chamber;
first and second chambers separated by the first peripheral transverse wall integral with the first coupling sleeve, each chamber being positioned between the second shaft and the first coupling sleeve, the first chamber being delimited by the first peripheral transverse wall and a second peripheral transverse wall integral with the second shaft, the second chamber being delimited by the first peripheral transverse wall and a third peripheral transverse wall integral with the second shaft.

This solution makes it possible to reduce the volume and the mass of the transmission device, the control being embedded in the decoupling system and comprising at least one element (the first coupling sleeve) common to said decoupling system.

The invention also relates to an aircraft propulsion assembly comprising a propulsion propeller, at least one electric motor and at least one transmission device according to one of the preceding features, the first shaft being coupled to the at least one electric motor or to the propulsion propeller and the second shaft being respectively coupled to the propulsion propeller or to the at least one electric motor.

### BRIEF DESCRIPTION OF THE DRAWINGS

Further features and advantages will become apparent from the following description of the invention, which is given by way of example only, with reference to the appended drawings, in which:

FIG. 1 is a schematic representation of an aircraft propulsion assembly illustrating one embodiment of the invention,

FIG. 2 is a perspective view of part of a transmission device of an aircraft propulsion assembly, illustrating a first embodiment of the invention, in the demounted state,

FIG. 3 is a longitudinal section of part of a transmission device which comprises a decoupling system illustrating a first embodiment of the invention, the decoupling system being in the coupled state,

FIG. 4 is a longitudinal section of the transmission device visible in FIG. 3, the decoupling system being in the decoupled state,

FIG. 5 is a longitudinal section illustrating in detail a control of the decoupling system visible in FIGS. 3 and 4,

FIG. 6 is a longitudinal section of part of a transmission device which comprises a decoupling system illustrating a second embodiment of the invention, the decoupling system being in the coupled state,

FIG. 7 is a longitudinal section of the transmission device visible in FIG. 6, the decoupling system being in the decoupled state.

### DETAILED DESCRIPTION OF THE PREFERRED EMBODIMENTS

According to one embodiment visible in FIGS. 2 to 4, 6 and 7, a transmission device 10 comprises a first shaft 12 having a first axis of rotation A12, a second shaft 14 having a second axis of rotation A14 parallel to the first axis of rotation A12 and a decoupling system 16 configured to occupy a coupled state in which the first and second shafts 12, 14 are coupled in rotation and a decoupled state in which the first and second shafts 12, 14 are not coupled in rotation. In the coupled state, when the first shaft 12 pivots and/or has a torque, its rotational movement and/or its torque are transmitted to the second shaft 14 by the decoupling system 16. Conversely, when the second shaft 14 pivots and/or has a torque, its rotational movement and/or its torque are transmitted to the first shaft 12 by the decoupling system 16. In the decoupled state, no torque and/or rotational movement are transmitted between the first and second shafts 12, 14.

For the remainder of the description, a longitudinal direction is parallel to the first and second axes of rotation A12, A14. A longitudinal plane contains the first and second axes of rotation A12, A14. A transverse plane and a radial direction are perpendicular to the longitudinal direction.

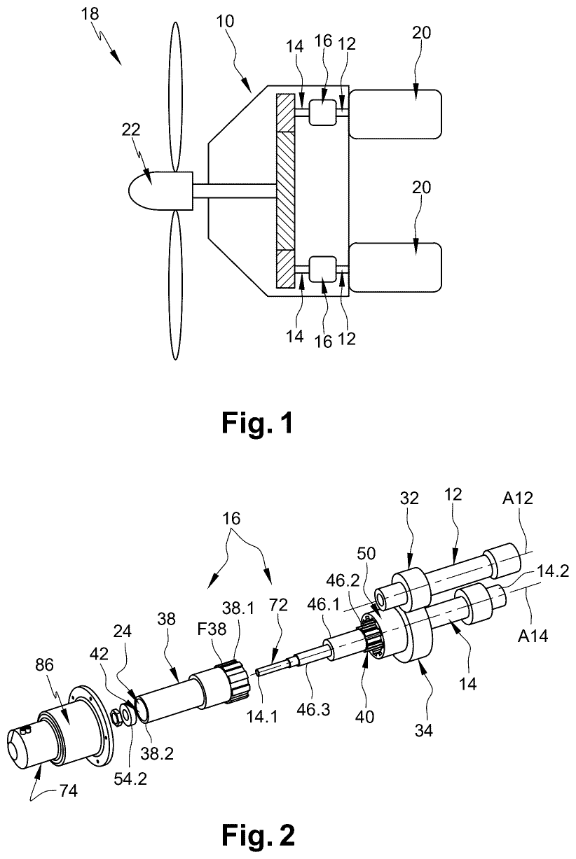

According to one embodiment visible in FIG. 1, a propulsion assembly 18 comprises at least one electric motor 20, at least one propeller 22 and at least one transmission device 10 which has a first shaft 12 coupled to the electric motor 20 and a second shaft 14 coupled to the propeller 22. According to one configuration, the propulsion assembly 18 comprises a single propeller 22, a plurality of electric motors 20 and a transmission device 10 which has a second shaft 14 coupled to the propeller 22 and, for each electric motor 20, a first shaft 12 and a decoupling system 16.

According to one application, an aircraft comprises at least one propulsion assembly 18. Of course, the invention is not limited to this application.

The transmission device 10 comprises at least one control 24 configured to control the coupled or decoupled state of the decoupling system 16.

According to one embodiment, the transmission device 10 comprises a structure 26, a first rotational guidance system 28 connecting the first shaft 12 and the structure 26 and allowing the first shaft 12 to pivot on itself, and a second rotational guidance system 30 connecting the second shaft 14 and the structure 26 and allowing the second shaft 14 to pivot on itself. By way of example and in a non-limiting manner, each of the first and second rotational guidance systems 28, 30 comprises at least one bearing or one rolling bearing.

According to a first embodiment visible in FIGS. 2 to 5, the first and second shafts 12, 14 are not aligned and the first and second axes of rotation A12, A14 are parallel and spaced apart from each other. The decoupling system 16 comprises a first pinion 32 coaxial with the first shaft 12 and fixed with respect to the latter, an intermediate pinion 34 configured to mesh with the first pinion 32, coaxial with the second shaft 14 and connected to the latter by a pivoting connection 36, and a first coupling sleeve 38 coaxial with the second shaft 14 and connected to the latter by a slide connection 40.

By way of example and in a non-limiting manner, the pivoting connection 36 comprises at least one bearing or one rolling bearing interposed between the intermediate pinion 34 and the second shaft 14.

The first coupling sleeve 38 extends between first and second ends 38.1, 38.2 and has a through-duct 42 connecting the first and second ends 38.1, 38.2. According to one arrangement, the first end 38.1 is closer to the intermediate pinion 34 than the second end 38.2.

The second shaft 14 and the through-duct 42 of the first coupling sleeve 38 respectively comprise a first shaft section 46.1 and a first sleeve section 48.1 which cooperate with each other so as to allow the first coupling sleeve 38 to slide along the second shaft 14. According to one configuration, the first shaft and sleeve sections 46.1, 48.1 are cylindrical and smooth, the first shaft section 46.1 having an outside diameter substantially equal to the inside diameter of the first sleeve section 48.1.

The second shaft 14 and the through-duct 42 of the first coupling sleeve 38 respectively comprise a second shaft section 46.2 and a second sleeve section 48.2 which cooperate with each other so as to rotationally immobilize the first coupling sleeve 38 with respect to the second shaft 14. According to one configuration, the second shaft and sleeve sections 46.2, 48.2 respectively comprise external and internal splines configured to cooperate with each other. According to one arrangement, the second shaft and sleeve sections 46.2, 48.2 are closer to the intermediate pinion 34 than the first shaft and sleeve sections 46.1, 48.1.

The first and second shaft and sleeve sections 46.1, 46.2, 48.1, 48.2 form the slide connection 40 connecting the second shaft 14 and the first coupling sleeve 38. Of course, the invention is not limited to this embodiment for obtaining the slide connection 40.

The intermediate pinion 34 comprises a second coupling sleeve 50, oriented towards the first coupling sleeve 38, which has a cylindrical inner surface F50. In addition, the first coupling sleeve 38 has a cylindrical outer surface F38 close to its first end 38.1 or which extends from the latter.

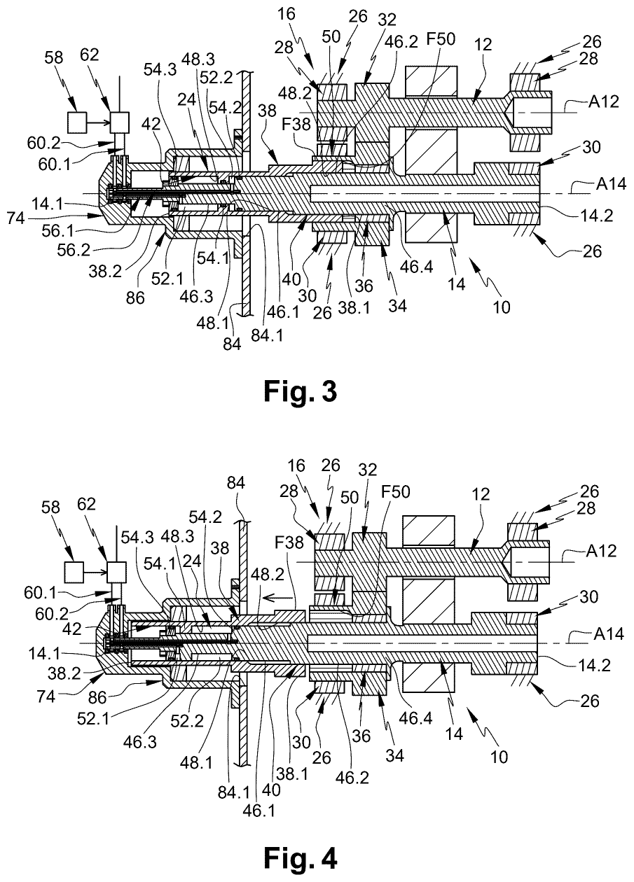

The first coupling sleeve 38 is configured to slide in the longitudinal direction along the second shaft 14 between a first position visible in FIG. 3, corresponding to the coupled state of the decoupling system 16, in which the inner surface F50 of the second coupling sleeve 50 of the intermediate pinion 34 and the outer surface F38 of the first coupling sleeve 38 overlap, and a second position visible in FIG. 4, corresponding to the decoupled state of the decoupling system 16, in which the inner surface F50 of the second coupling sleeve 50 of the intermediate pinion 34 and the outer surface F38 of the first coupling sleeve 38 are offset with respect to each other in the longitudinal direction. The inner surface F50 of the second coupling sleeve 50 of the intermediate pinion 34 and the outer surface F38 of the first coupling sleeve 38 are configured to cooperate with each other when the first coupling sleeve 38 occupies the first position and to rotationally immobilize the first and second coupling sleeves 38, 50 with respect to each other. According to one embodiment, the inner surface F50 of the second coupling sleeve 50 of the intermediate pinion 34 comprises internal splines. In addition, the outer surface F38 of the first coupling sleeve 38 comprises external splines configured to cooperate with the internal splines of the inner surface F50 of the second coupling sleeve 50 of the intermediate pinion 34. According to a preferred configuration, the internal and external splines are configured to promote the engagement of the external splines between the internal splines when the first coupling sleeve 38 passes from the second position to the first position.

Of course, the invention is not limited to this embodiment for coupling the first and second coupling sleeves 38, 50 in rotation when the first coupling sleeve 38 is in the first position.

In operation, whatever the position of the first coupling sleeve 38, the first shaft 12 and the intermediate pinion 34 are coupled in rotation. Thus, when the first shaft 12 pivots, it rotates the intermediate pinion 34. When the first coupling sleeve 38 occupies the first position corresponding to the coupled state, the intermediate pinion 34, the first coupling sleeve 38 and the second shaft 14 are coupled in rotation. Thus, when the intermediate pinion 34 pivots, it rotates the first coupling sleeve 38 which itself rotates the second shaft 14. When the first coupling sleeve 38 occupies the second position corresponding to the decoupled state, the intermediate pinion 34 and the first coupling sleeve 38 are no longer coupled in rotation. Consequently, when the intermediate pinion 34 pivots, it does not rotate the first coupling sleeve 38. In parallel, when the second shaft 14 pivots, it rotates the first coupling sleeve 38 which does not rotate the intermediate pinion 34 coupled to the first shaft 12.

According to a second embodiment visible in FIGS. 6 and 7, the first and second axes A12, A14 of the first and second axes are coincident, the first and second shafts 12, 14 being aligned. According to this embodiment, the decoupling system 16 does not comprise an intermediate pinion 34. The second coupling sleeve 50 is positioned at one end of the first shaft 12 and forms with the latter one and the same component.

The first coupling sleeve 38 extends between first and second ends 38.1, 38.2 oriented respectively towards the first and second shafts 12, 14 and comprises:
a first part 38A which extends from the first end 38.1 and which is configured to cooperate with the second coupling sleeve 50 when the first coupling sleeve 38 is in a first position and no longer cooperate with the second coupling sleeve 50 when the first coupling sleeve 38 is in a second position; and
a second part 38B which extends from the second end 38.2 and which is connected to the second shaft 14 by a slide connection 40.

When the first coupling sleeve 38 occupies the first position, as illustrated in FIG. 6, the first shaft 12 and the first coupling sleeve 38 are coupled in rotation. When the first coupling sleeve 38 occupies the second position, as illustrated in FIG. 7, the first shaft 12 and the first coupling sleeve 38 are decoupled.

Whatever the embodiment, the transmission device 10 comprises:
a first shaft 12 directly or indirectly coupled to a first element among a drive system configured to generate a rotational movement and/or a torque, such as an electric motor for example, and a receiving system configured to be rotated and/or receive a torque, such as a propeller for example;
a second shaft 14 directly or indirectly coupled to a second element different from the first element among the drive system and the receiving system; and,
a decoupling system 16 which comprises at least one first coupling sleeve 38 permanently coupled in rotation with the second shaft 14 and connected by a slide connection 40 to the latter, said first coupling sleeve 38 being movable along the second shaft 14 in a longitudinal direction between a first position in which the first coupling sleeve 38 is coupled in rotation with the first shaft 12 and a second position in which the first coupling sleeve 38 is not coupled in rotation with the first shaft 12.

According to one embodiment visible in FIGS. 3 to 5, the control 24 comprises first and second chambers 52.1, 52.2 situated between the second shaft 14 and the first coupling sleeve 38, more precisely between third shaft and sleeve sections 46.3, 48.3, and separated by a first peripheral transverse wall 54.1 integral with the first coupling sleeve 38, the first chamber 52.1 being delimited by the first peripheral transverse wall 54.1 and a second peripheral transverse wall 54.2 integral with the second shaft 14, the second chamber 52.2 being delimited by the first peripheral transverse wall 54.1 and a third peripheral transverse wall 54.3 integral with the second shaft 14. In addition, the control 24 comprises at least one first fluid supply 56.1 configured to supply the first chamber 52.1 with fluid, at least one second fluid supply 56.2 configured to supply the second chamber 52.2 with fluid, and at least one controller 58 configured to control the first and second fluid supplies 56.1, 56.2 while allowing or not allowing a flow therein.

The first and second chambers 52.1, 52.2 have first and second volumes which vary in a synchronized and inversely proportional manner. Thus, when the first volume decreases, the second volume increases, and vice versa. In operation, a variation in the first and second volumes causes a translational movement of the first peripheral transverse wall 54.1 and of the first coupling sleeve 38 with respect to the second shaft 14 in the longitudinal direction in first and second opposite directions.

According to one arrangement, when the first volume of the first chamber 52.1 increases and/or is maximum (and the second volume of the second chamber 52.2 decreases and/or is minimum), the first coupling sleeve 38 translates from the second position to the first position and/or occupies the first position. When the second volume of the second chamber 52.2 increases and/or is maximum (and the first volume of the first chamber 52.1 decreases and/or is minimum), the first coupling sleeve 38 translates from the first position to the second position and/or occupies the second position.

According to one configuration, the first fluid supply 56.1 comprises at least one first fluid supply duct 60.1 which has a first end opening out into the first chamber 52.1 and a second end connected to a fluid source. The second fluid supply 56.2 comprises at least one second fluid supply duct 60.2 which has a first end opening out into the second chamber 52.2 and a second end connected to a fluid source. According to one arrangement, the first and second fluid supplies 56.1, 56.2 have a common fluid source and at least one distribution system 62 interposed between the fluid source and the second ends of the first and second fluid supply ducts 60.1, 60.2 and configured to orient the fluid from the fluid source to the first fluid supply duct 60.1 or the second fluid supply duct 60.2 alternately.

In operation, the fluid source generates a hydraulic power. By way of example, the hydraulic power is taken from at least one lubrication or cooling system of the transmission device 10 or from a hydraulic system present in the vicinity of the transmission device 10. Depending on the case, the fluid source is exclusively dedicated to the decoupling system 16 or shared with other elements of the propulsion assembly.

The controller 58 can be centralized or decentralized. In the presence of a plurality of electric motors 20 each associated with a decoupling system 16, the controller 58 is configured to control the various decoupling systems 16 according to the use requirements (power required according to the flight phases) and to mechanically isolate a failed electric motor or to perform a test.

When the aircraft is static on the ground, the stationary electric motors 20 are still coupled to the propeller 22 which still remains blocked because of the resistive torque of the electric motors 20, whatever the direction of the wind forces on the propeller 22.

As a variant, the control 24 could comprise a single fluid supply configured to supply the first chamber 52.1 and at least one return system positioned in the second chamber 52.2. In this case, when the first chamber 52.1 is supplied with fluid at a pressure greater than or equal to a given threshold (which depends on the return system), the first coupling sleeve 38 moves towards the first position against the return system and/or is positioned in the first position. When the first chamber 52.1 is not supplied with fluid or is supplied with fluid at a pressure lower than the given threshold, the first coupling sleeve 38 moves towards the second position and/or is positioned in the second position by means of the return system.

According to one embodiment visible in FIGS. 3 to 5, the second shaft 14 comprises a fourth shaft section 46.4 at which the pivoting connection 36 is positioned. In this case, the second shaft 14 extends between first and second ends 14.1, 14.2 and the first, second, third and fourth shaft sections 46.1 to 46.4 are stepped sections; the third shaft section 46.3 being closest to the first end 14.1, the fourth shaft section 46.4 being closest to the second end 14.2, the first and second shaft sections 46.1, 46.2 being situated between the third and fourth shaft sections 46.3, 46.4, the first shaft section being adjacent to the third shaft section 46.3, the second shaft section 46.2 being adjacent to the fourth shaft section 46.4.

According to one configuration, the second peripheral transverse wall 54.2 is a shoulder connecting the first and third shaft sections 46.1, 46.3. The third peripheral transverse wall 54.3 is a washer connected to the first end 14.1 of the second shaft 14 by means of a nut. Of course, the invention is not limited to this configuration for the second and third peripheral transverse walls 54.2, 54.3.

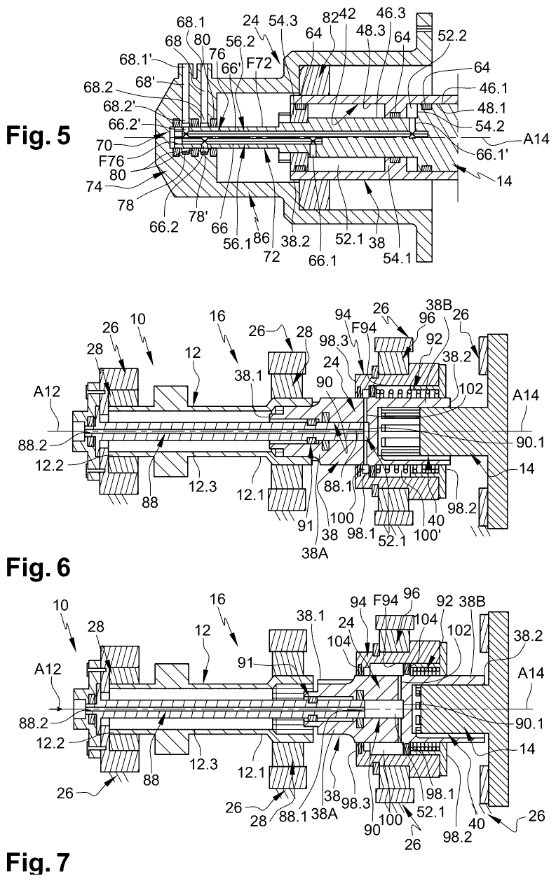

As illustrated in FIG. 5, the control 24 comprises various sliding seals 64 between the first peripheral transverse wall 54.1 and the second shaft 14 and between each of the second and third transverse walls 54.2, 54.3 and the first coupling sleeve 38 to obtain first and second sealed chambers 52.1, 52.2.

According to one embodiment visible in FIG. 5, each of the first and second fluid supply ducts 60.1, 60.2 comprises a first section 66, 66′ provided in the second shaft 14 and a second static section 68, 68′, and a connection system 70 connecting the first and second sections 66, 66′, 68, 68′.

As illustrated in FIG. 5, the connection system 70 comprises a cylindrical extension 72 of the second shaft 14, the latter having a first cylindrical lateral face F72. Each first section 66, 66′ comprises a first end 66.1, 66.1′ which opens out into the first or second chamber 52.1, 52.2 and a second end 66.2, 66.2′ which opens out at the first lateral face F72 of the extension 72. The second ends 66.2, 66.2′ of the first sections 66, 66′ of the first and second fluid supply ducts 60.1, 60.2 are offset with respect to each other in the longitudinal direction.

The connection system 70 comprises a static end piece 74, integral with the structure 26 of the transmission device 10, which has a cylindrical receptacle 76 configured to receive the extension 72 of the second shaft 14. Thus, the receptacle 76 comprises a second cylindrical lateral face F76, facing the first lateral face F72 of the extension 72, which has a diameter substantially equal to that of the first lateral face F72. Thus, the extension 72 can pivot without play in the receptacle 76.

Each second section 68, 68′ comprises a first end 68.1, 68.1′ which opens out to the outside of the end piece 74 and a second end 68.2, 68.2′ which opens out into a peripheral groove 78, 78′ provided at the second lateral face F76 of the receptacle 76. The peripheral grooves 78, 78′ of the second sections 68, 68′ of the first and second fluid supply ducts 60.1, 60.2 are offset with respect to each other in the longitudinal direction.

The extension 72 and the end piece 74 are arranged with respect to each other in such a way that, for each of the first and second fluid supply ducts 60.1, 60.2, the second end 66.2, 66.2′ of the first section 66, 66′ opens out in line with the peripheral groove 78, 78′ of the corresponding second section 68, 68′.

To reinforce the sealing, the transmission device 10 comprises rotating seals 80 positioned on either side of the peripheral grooves 78, 78′, between the extension 72 and the end piece 74.

According to one embodiment, the transmission device 10 comprises a sliding and rotating bearing 82 between the first coupling sleeve 38 and the end piece 74.

According to one configuration visible in FIGS. 3 and 4, the transmission device 10 comprises a casing 84 which has a through-orifice 84.1 provided to allow the passage of the second shaft 14 and the first coupling sleeve 38, and a stopper 86 removably connected to the casing 84 and configured to close off the through-orifice 84.1, said stopper 86 incorporating the end piece 74.

Of course, the invention is not limited to this solution for the first and second fluid supply ducts 60.1, 60.2 and the connection system 70.

According to a second embodiment visible in FIGS. 6 and 7 and adapted for a decoupling system 16 which has aligned first and second shafts 12, 14, the first shaft 12 is hollow, extends between first and second ends 12.1, 12.2 and comprises a through-duct 12.3 which connects the first and second ends 12.1, 12.2 and opens out inside the second coupling sleeve 50.

According to this second embodiment, the control 24 comprises a rigid fluid supply duct 88 which extends between first and second ends 88.1, 88.2 and which is housed in the through-duct 12.3 of the first shaft 12, the second end 88.2 being connected to a fluid source. This fluid supply duct 88 is connected to the structure 26 of the transmission device 10 by a connection immobilizing it at least in translation in the longitudinal direction. This connection may be a pivoting connection.

In addition, the first coupling sleeve 38 comprises, at its first part 38A, a receptacle 90 configured to house the first end 88.1 of the fluid supply duct 88. The first coupling sleeve 38 and the fluid supply duct 88 are connected by a slide connection 91 configured to allow the first coupling sleeve 38 to slide with respect to the fluid supply duct 88 in the longitudinal direction. This slide connection 91 comprises at least one key interposed between the first coupling sleeve 38 and the fluid supply duct 88. This assembly of the fluid supply duct 88 makes it possible to dissociate the dynamic sealing functions of translation and rotation.

The receptacle 90 and the fluid supply duct 88 delimit a first chamber 52.1 which has a variable volume. The receptacle 90 has a bottom 90.1 substantially perpendicular to the longitudinal direction. Thus, when the first chamber 52.1 is supplied with fluid, the volume of the first chamber 52.1 increases and the first coupling sleeve 38 translates from the first position to the second position and/or is maintained in the second position.

According to this second embodiment, the control 24 comprises at least one return system 92 configured to push the first coupling sleeve 38 into the first position and/or maintain it in this first position.

According to one configuration, the control 24 comprises a tubular housing 94 positioned around the first coupling sleeve 38 and connected to the structure 26 of the transmission device 10 by a connection 96 immobilizing it in translation in the longitudinal direction and possibly allowing it to pivot on itself. This tubular housing 94 is substantially coaxial with the first coupling sleeve 38 and with the first and second shafts 12, 14. The tubular housing 94 has a substantially cylindrical inner surface F94 spaced apart from an outer surface F38 of the first coupling sleeve 38. The latter comprises a first peripheral transverse wall 98.1, projecting with respect to its outer surface F38, which forms a piston integral with the first coupling sleeve 38 and sliding in the tubular housing 94. In addition, the tubular housing 94 comprises a second peripheral transverse wall 98.2 projecting with respect to its inner surface F94. According to this configuration, the return system 92 is positioned between the first and second peripheral transverse walls 98.1, 98.2. By way of example, the return system is a compression spring interposed between the first and second peripheral transverse walls 98.1, 98.2.

According to one arrangement, the tubular housing 94 comprises a third peripheral transverse wall 98.3 projecting with respect to its inner surface F94, the first peripheral transverse wall 98.1 integral with the first coupling sleeve 38 being positioned between the second and third peripheral transverse walls 98.2, 98.3 integral with the tubular housing 94. According to this arrangement, the control 24 comprises a first annular chamber 100 delimited by the first coupling sleeve 38, the tubular housing 94 and the first and third peripheral transverse walls 98.1, 98.3, and a second annular chamber 100′ (in which the return system 92 is positioned) delimited by the first coupling sleeve 38; the tubular housing 94, the first and second peripheral transverse walls 98.1, 98.2 and at least one radial channel 102 connecting the first chamber 52.1 and the first annular chamber 100. In order to reinforce the sealing of the latter, sliding seals 104 are interposed, on the one hand, between the first peripheral transverse wall 98.1 and the tubular housing 94 and, on the other hand, between the third peripheral transverse wall 98.3 and the first coupling sleeve 38.

According to this second embodiment, when the first chamber 52.1 is supplied with fluid, the pressure of the fluid increases in the first chamber 52.1 and the annular chamber 100, causing an increase in the volume of said chambers 52.1, 100. When this pressure becomes greater than or equal to a given threshold value which is a function of the return system 92, the first coupling sleeve 38 translates from the first position to the second position and is maintained in this second position against the return system 92. Consequently, the first and second shafts 12, 14 are decoupled. When the pressure of the fluid inside the first chamber 52.1 and the annular chamber 100 is less than the given threshold value, the first coupling sleeve returns to the first position or is maintained in this first position by means of the return system 92.

Of course, the invention is not limited to these embodiments for the control 24.

Whatever the embodiment, the control 24 comprises at least one chamber 52.1, 100 adjoining the first coupling sleeve 38 and having a variable volume, at least one fluid supply 56.1, 56.2, 88 configured to supply fluid to the chamber 52.1, 100, and a controller 58 configured to control the fluid supply 56.1, 56.2, 88; a variation in the volume of the chamber 52.1, 100 causing a change in position of the first coupling sleeve 38. “Adjoining” is understood to mean that a surface of the first coupling sleeve 38 delimits the chamber 52.1, 100.

The chamber 52.1, 100 may be positioned inside the first coupling sleeve 38 (as illustrated in FIGS. 3 to 7) and/or around the first coupling sleeve 38 (as illustrated in FIGS. 6 and 7).

According to one configuration, the control 24 comprises at least one first peripheral transverse wall 54.1, 98.1 which extends in a direction substantially perpendicular to the longitudinal direction, said first peripheral transverse wall 54.1, 98.1 being integral with the first coupling sleeve 38 and delimiting at least one chamber 52.1, 52.2 whose volume is variable. According to a first embodiment, the first peripheral transverse wall 54.1, 98.1 separates first and second chambers 52.1, 52.2. According to a second embodiment, the first peripheral transverse wall 54.1, 98.1 separates a first chamber 52.1 and a return system 92. Thus, in the manner of a jack, the first peripheral transverse wall 54.1, 98.1 forms a piston and the first coupling sleeve 38 forms a rod integral with the piston. In the presence of two chambers 52.1, 52.2 supplied with fluid, the decoupling system 16 is of the bistable type. In the presence of a return system, the decoupling system 16 is of the monostable type.

Whatever the embodiment, the control 24 is at least partially integrated into the decoupling system 16 and comprises elements common to said decoupling system 16, which makes it possible to reduce the volume and the mass of the transmission device 10.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A transmission device comprising:
a first shaft and a second shaft; and
at least one decoupling system configured to occupy a coupled state in which the first shaft and the second shaft are coupled in rotation and a decoupled state in which the first shaft and the second shaft are decoupled in rotation; and,
at least one control configured to control the coupled state or the decoupled state of the at least one decoupling system,
wherein the at least one decoupling system comprises at least one first coupling sleeve which is permanently coupled in rotation with the second shaft and movable along the second shaft between a first position, corresponding to the coupled state, in which the at least one first coupling sleeve is coupled in rotation with the first shaft, and a second position, corresponding to the decoupled state, in which the at least one first coupling sleeve is not coupled in rotation with the first shaft,
wherein the at least one control comprises at least one chamber adjoining the at least one first coupling sleeve and having a variable volume, at least one fluid supply configured to supply fluid to the at least one chamber, and at least one controller configured to control a fluid supply, a variation in the variable volume of the at least one chamber causing a change in position of the at least one first coupling sleeve,
wherein the at least one control further comprises at least one first peripheral transverse wall integral with the at least one first coupling sleeve and delimiting the at least one chamber,
wherein the at least one chamber includes a first chamber and a second chamber separated by the at least one first peripheral transverse wall integral with the at least one first coupling sleeve, and,
wherein the first chamber and the second chamber are both positioned between the second shaft and the at least one first coupling sleeve, the first chamber being delimited by the at least one first peripheral transverse wall and a second peripheral transverse wall integral with the second shaft, the second chamber being delimited by the at least one first peripheral transverse wall and a third peripheral transverse wall integral with the second shaft.

2. The transmission device according to claim 1, wherein the at least one fluid supply comprises a first fluid supply and a second fluid supply, respectively, supplying the first and second chambers.

3. The transmission device according to claim 1, wherein the control comprises at least one return system configured to push the at least one first coupling sleeve into the first position, or to maintain the at least one first coupling sleeve in the first position, or both.

4. The transmission device according to claim 1, wherein the control comprises, for each chamber, at least one fluid supply duct comprising a first section provided in the second shaft and a second section, the second section being a static section, and a connection system connecting the first section and the second section.

5. The transmission device according to claim 4, wherein the connection systems each comprise:
a cylindrical extension of the second shaft which has a first cylindrical lateral face at which each first section opens out;
a static end piece which has a cylindrical receptacle configured to receive the cylindrical extension of the second shaft and comprising a second cylindrical lateral face facing the first lateral face of the cylindrical extension, each second section opening out into a peripheral groove provided at the second lateral face; and,
the cylindrical extension and the static end piece arranged with respect to each other in such a way that, for each fluid supply duct, the first section opens out in line with the peripheral groove at which the corresponding second section opens out.

6. The transmission device according to claim 5, further comprising:
a casing which has a through-orifice provided to allow a passage of the second shaft and a passage of the at least one first coupling sleeve; and
a stopper removably connected to the casing and configured to close off the through-orifice, said stopper incorporating the static end piece.

7. The transmission device according to claim 1, wherein the first shaft and the second shaft are not aligned, and
wherein the at least one decoupling system further comprises a first pinion coaxial with the first shaft and fixed thereto, and an intermediate pinion configured to mesh with the first pinion, coaxial with the second shaft and connected thereto by a pivoting connection, said intermediate pinion comprising a second coupling sleeve configured to be coupled in rotation with the at least one first coupling sleeve when the at least one first coupling sleeve is in the first position.

8. An aircraft propulsion assembly comprising:
a propeller;
at least one electric motor; and
at least one transmission device according to claim 1,
the first shaft coupled to one of the at least one electric motor or to the propeller, and the second shaft coupled to the other of the at least one electric motor or to the propeller.
